(19) United States
(12) Patent Application Publication
(10) Pub. No.: US 2015/0368133 A1
(43) Pub. Date: Dec. 24, 2015

(54) PROCESS FOR TREATING WATERS PRODUCED OR COLLECTED FROM THE OIL EXTRACTION IN MINING OPERATIONS AND REDUCING THE TENDENCY OF CALCIUM SCALING OF PROCESS EQUIPMENT

(71) Applicant: VEOLIA WATER TECHNOLOGIES, INC., Moon Township, PA (US)

(72) Inventors: David E. Gamache, Oswego, IL (US); Justin Scurte, Yorkville, IL (US)

(73) Assignee: VEOLIA WATER TECHNOLOGIES, INC., Moon Township, PA (US)

(21) Appl. No.: 14/748,950

(22) Filed: Jun. 24, 2015

Related U.S. Application Data
(60) Provisional application No. 62/016,127, filed on Jun. 24, 2014.

(51) Int. Cl. C02F 5/02; C02F 1/28; C02F 1/20; C02F 1/44; C02F 1/04

(52) U.S. Cl. CPC C02F 5/02; C02F 1/44; C02F 1/048; C02F 1/20; C02F 1/281; C02F 2101/10

(57) ABSTRACT

Oil sands process water (OSPW) is directed to an evaporator that evaporates the OSPW and produces steam and a concentrated brine. The OSPW includes alkalinity and calcium hardness. To inhibit calcium carbonate scaling of the evaporator, magnesium oxide is mixed with the OSPW, resulting in the precipitation of magnesium hydroxide which acts as a seed material for calcium carbonate precipitation to prevent fouling. The process crystallizes the calcium carbonate and the mixture of magnesium hydroxide and calcium carbonate crystals are circulated through the evaporator as well as recirculated to a point upstream of the evaporator.

### FIELD OF THE INVENTION

The present invention relates to processes for treating wastewater and more particularly to a process for treating oil sands process water and other industrial wastewater employing an evaporator.

### BACKGROUND OF THE INVENTION

Oil sands are deposits that are generally made up of bitumen, clay, sand and water and form a large part of the oil reserves in North America. In order to recover oil from oil sands, the bitumen is extracted from the oil sands. There are various processes used to extract bitumen, depending on geographical locations. For example, bitumen maybe recovered by surface mining or in-situ thermal processes such as stream-assisted gravity discharge, which is sometimes referred to as a SAGD process.

Oil sands process affected water (sometimes referred to as OSPW or simply oil sands process water) refers to water that has been in contact with oil sands or released from oil sands deposits. For example, in a SAGD process, an oil-water mixture is removed from an oil-bearing formation and the oil is separated from the mixture leaving what is referred to as produced water. As used herein, produced water is an oil sands process water. In this example, the resulting produced water typically includes suspended solids and dissolved solids that must be removed from the produced water prior to the produced water being used, for example, to generate steam that is used in the SAGD process. Another example of oil sands process water is tailings pond water. Tailings pond water is found in ponds or lagoons and generally results from the surface mining of bitumen in oil sands regions such as those in Alberta, Canada. Like produced water, tailings pond water must be treated prior to discharge or being used to generate steam or used as process makeup water. Another type of oil sand process waters is basal water. Basal water comes from a basal aquifer, situated underneath the oil sands geological layer. In mining operations, depressurizing the basal aquifer is one of the key goals for achieving a safe and productive mining operation. As a result of depressurization of the basal aquifer, basal water is collected at the surface of the oil formation. Basal water must be treated prior to discharge. Basal water can also be blended with other oil sands process waters (such as produced water) and used to generate steam through an evaporation process.

Many oil sands process waters and other industrial wastewater include significant concentrations of alkalinity (bicarbonate and carbonate), as well as calcium hardness. The presence of calcium and alkalinity in the oil sands process water often leads to the precipitation of calcium which is a scaling compound. In processes that employ evaporators for example, calcium carbonate scaling can be a serious problem. This is because the calcium carbonate precipitants scale the heat transfer tubes of the evaporator, substantially decreasing the efficiency of the evaporator and requiring expensive and time-consuming cleaning and maintenance.

In the past, calcium carbonate scaling of evaporator and process equipment has been dealt with upstream of the evaporator or process equipment by acidification and degasification. This process reduces the alkalinity concentration in the wastewater stream. However, acidification and degasification have serious drawbacks. The acid cost can be prohibitive if the wastewater has a high alkalinity concentration. In addition, in some applications where organics are present in the wastewater, the organics precipitate in response to acidification. In other cases, an ion exchange softening unit is employed upstream of the evaporator or other process equipment. This process reduces the concentration of calcium and magnesium in the wastewater. This process also has some drawbacks. The use of an ion exchange softening unit adds extra cost and generates a liquid waste stream which often requires treatment. Also, as a practical matter, there is a limitation on the calcium concentration to be treated by ion exchange resin. Another option for dealing with wastewater streams having a relatively high alkalinity concentration and hardness is employing a chelant inside the evaporator or other process equipment. This chelant maintains calcium in a soluble form and hence prevents precipitation. The drawback here is that the efficiency is limited and chelants are expensive.

The present invention provides a process for treating oil sands process water and other industrial wastewater with an evaporator wherein the process is designed to inhibit calcium carbonate scaling of the evaporator heat transfer tubes and other process equipment that might be used.

### SUMMARY OF THE INVENTION

The present invention entails a process that reduces the tendency of calcium to scale process equipment. Fundamentally, the process entails adding a source of magnesium to a feedwater to form magnesium hydroxide, which in turn allows calcium to precipitate without scaling.

In one embodiment, the method entails treating oil sands process water having alkalinity and calcium hardness. Oil sands process water is directed to an evaporator that produces steam and a concentrated brine. Calcium scaling of the evaporator is inhibited by mixing magnesium oxide with the oil sands process water and precipitating magnesium hydroxide . The precipitated magnesium hydroxide may act as a seed for calcium compounds such as calcium carbonate to precipitate. Magnesium hydroxide and calcium-based crystals, along with the oil sands process water, is directed to the evaporator where the magnesium hydroxide and calcium-based crystals are mixed with the concentrated brine. The method includes circulating the concentrated brine, magnesium hydroxide and calcium-based crystals through the evaporator. Further, the method includes circulating at least some of the concentrated brine and mixed crystal slurry therein to a point upstream of the evaporator and mixing the concentrated brine and mixed crystal slurry with the oil sands process water. This crystallization process incorporated into the overall process of treating the oil sands process water inhibits or reduces calcium carbonate scaling of the evaporator heat transfer tubes.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic illustration of a process for treating oil sands process affected water.

FIG. 2 is a schematic illustration showing a process for treating tailings pond water.

### DESCRIPTION OF EXEMPLARY EMBODIMENTS

The present invention, in one embodiment, relates to treating what is referred to as oil sands process affected water. The term “oil sands process affected water” comprises various water that has been in contact with oil sands. Examples of these waters are produced water that results in a SAGD process and tailings pond water resulting from the surface mining of bitumen. With water being relatively scarce in many parts of the world, coupled with the need to protect the environment, it has become necessary to treat and purify oil sands process water in order that the water can be productively re-used or safely discharged.

As will be discussed below, the oil sands process water is treated or purified by an evaporator. The evaporator evaporates the oil sands process water, generating steam and a concentrated brine. The steam is condensed and forms a distillate. The distillate can be used to generate steam or can be used as process makeup water or can be discharged. Typically, oil sands process water includes a relatively high concentration of alkalinity (sometimes as high as 2000 ppm) in the form of bicarbonate and, depending on the pH, carbonate. Along with the alkalinity, it is not uncommon for oil sands process water to include a significant concentration of hardness (for example, 50 ppm) in the form of calcium and, in some cases, magnesium. Because of the presence of alkalinity and calcium hardness, the oil sands process water is prone to scaling process equipment. Calcium carbonate precipitates from the water and scales equipment surfaces, such as the heat transfer surfaces of evaporators. This is a problem because calcium carbonate scaling substantially decreases the efficiency of the evaporator and requires significant cleaning and maintenance. As discussed herein, the process described adds a magnesium source, such as magnesium oxide, to a feedwater stream and this results the precipitation of magnesium hydroxide which acts as a seed for calcium carbonate and allows calcium carbonate to precipitate without scaling downstream process equipment.

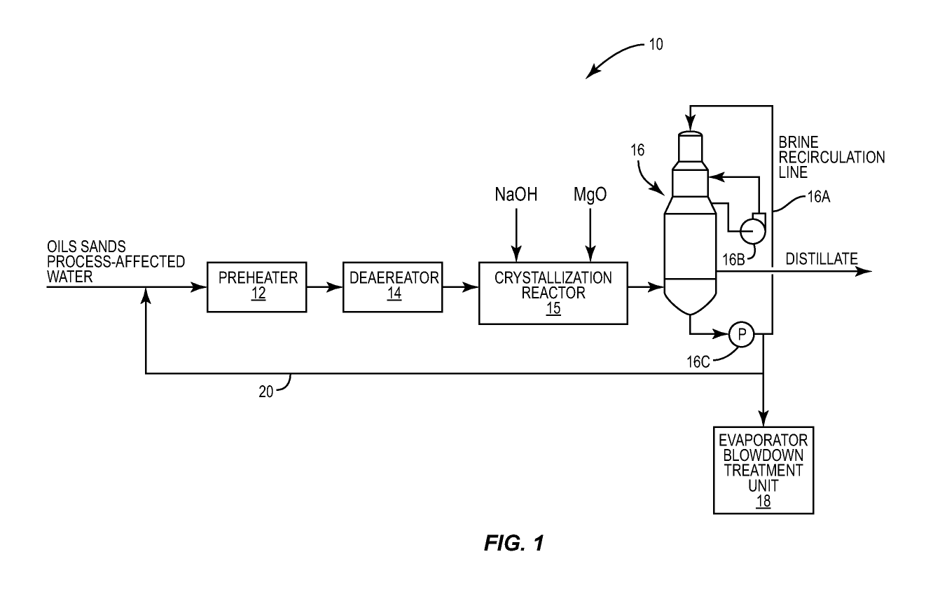

With reference to the drawings, particularly FIG. 1, there is shown therein a process for treating oil sands process water. The oil sands process water is directed through a pre-heater 12 for heating the same. Various types of pre-heaters can be utilized. In one embodiment, the pre-heater 12 includes a heat exchanger through which the oil sands process water passes. Various heat sources can be utilized to supply heat to the pre-heater 12. In one embodiment, a distillate stream produced by a downstream evaporator can be directed through the pre-heater 12 for heating the oil sands process water. In any event, heating the oil sands process water will at least slightly decrease the solubility of calcium carbonate and this will result in some calcium carbonate in the oil sands process water precipitating.

From the pre-heater 12, the oil sands process affected water is directed to a deaerator 14 that removes oxygen, carbon dioxide and other non-condensable gases from the water passing through the deaerator. It should be noted that pre-heating and de-aerating the oil sands process water is optional.

After treatment in the deaerator 14, the oil sands process water is directed to a crystallization reactor 15. Crystallization reactor 15 can include one or more mixed tanks. In the embodiment illustrated herein, magnesium oxide is added to the oil sands process water and mixed therewith. The magnesium oxide will react with the water and form magnesium hydroxide, among other compounds. This results in the precipitation of magnesium hydroxide which acts as a seed for calcium compounds and allows calcium compounds to precipitate in a manner that does not result in significant scaling of downstream process equipment. As presented herein, the calcium species or compounds that is discussed is calcium carbonate. It should be understood, however, that the process described herein is directed at precipitating calcium species or calcium compound that are prone to scale process equipment, such as evaporator heat transfer tubes. Thus, the process of the present invention entails utilizing magnesium oxide or a source of magnesium to precipitate calcium species or compounds and to prevent these calcium species or compounds from scaling process equipment. Calcium carbonate, discussed throughout this application, is one example of a calcium species or calcium compound that is precipitated as a result of mixing magnesium oxide or a magnesium source with the water being treated. Adding the magnesium oxide also increases the pH of the oil sands process water. In one embodiment, it is contemplated that the pH of the oil sands process water is raised to 10.2 to 11.5. This increase in pH lowers the solubility of calcium carbonate and result in calcium carbonate precipitating. In some cases, a caustic is added to assure an appropriate pH range. For example, sodium hydroxide can be added to the oil sands process water in the crystallization reactor 15 to assure that the pH is raised to approximately 10.2 to approximately 11.5. Thus, in the crystallization reactor, calcium carbonate will precipitate from the oil sands process water. The resulting calcium carbonate precipitants will begin to crystallize in the crystallization reactor 15.

The oil sands process water, along with the magnesium hydroxide and calcium carbonate crystals, are transferred from the crystallization reactor 15 to a downstream evaporator 16. More particularly, the water, along with the mixed crystals, are directed into the sump of the evaporator 16. There the oil sands process water and crystals are mixed with concentrated brine produced by the evaporator 16. The concentrate brine having the magnesium hydroxide and calcium carbonate crystals is pumped by the pump 16C through a brine recirculation line 16A to a top portion of the evaporator 16. Here the concentrated brine is dispersed, in this exemplary evaporator, into vertical heat transfer tubes. The concentrated brine forms a thin film on the inside surfaces of the heat transfer tubes and falls downwardly therethrough. The heat transfer tubes are heated with steam causing the concentrated brine having the crystals therein to be further concentrated and to produce a vapor. In this example, the evaporator 16 is a mechanical vapor recompression evaporator. Accordingly, the vapor produced from the concentrated brine is directed to a compressor 16B which compresses the vapor and produces steam which is directed against the outside of the heat transfer tubes, again heating the thin film brine falling downward along the inside of the tubes. The steam condenses and produces a distillate that is directed from the evaporator. The distillate can be used in a variety of ways. It may be directed to a steam generator for producing steam that is utilized in a SAGD operation. On the other hand, the distillate may be used as a makeup process water or may be appropriately discharged.

A portion of the concentrated brine is directed from the evaporator 16 as evaporator blowdown. The evaporator blowdown maybe directed to an evaporator blowdown treatment unit 18 for further treatment. Here the evaporator blowdown can be further concentrated or subjected to a crystallizing process in a crystallizer which can produce a zero liquid discharge. In other cases, the evaporator blowdown can be subjected to a suspended solids removal process that removes suspended solids therefrom, after which the treated evaporator blowdown stream can be disposed of through deep well injection.

Another portion of the concentrated brine, along with the crystals therein, is recirculated and mixed with the oil sands process water at various points upstream of evaporator 16. In the embodiment illustrated in FIG. 1, the concentrated brine and crystals therein are shown being recirculated to a point ahead of the pre-heater 12. It is understood and appreciated that the concentrated brine or a portion thereof can be recirculated to the crystallization reactor 15. In any event, by recirculating the concentrated brine and the crystals to the main stream of the process facilitates the further crystallization of the calcium carbonate. Over time and due, in part at least, to the recirculation of the concentrated brine, the calcium carbonate particles grow into crystals and, because of the presence of the magnesium hydroxide seed, calcium carbonate scaling of the evaporator heat transfer tubes is reduced or even eliminated.

In some cases, the oil sands process water includes a significant concentration of silica. Silica is also susceptible to scaling the heat transfer tubes of the evaporator 16. To reduce silica scaling, the magnesium oxide added to the crystallization reactor 15 reacts with the water to form magnesium hydroxide crystals.

The magnesium hydroxide crystals effectively adsorb or pull silica out of solution. The elevated pH, due to adding magnesium oxide and possibly a caustic, reduces the solubility of magnesium hydroxide. Substantial amounts of the silica in the form of silica-based compounds in the oil sands process water is drawn out of solution via adsorption by the magnesium hydroxide crystals. The dissolved silica concentration in the oil sands process water is thus reduced to a relatively low level. The concentration of the remaining silica in solution is typically below the solubility limits and thus does not scale the evaporator heat transfer tubes.

Another form of oil sands process water is tailings pond water. Oil sand is typically comprised of 80-85% minerals, 10-15% bitumen and 3-4% water by weight. The mineral component of the oil sand contains both sand and fines. Bitumen is separated from oil sand using what is sometimes referred to as a hot water extraction process. The remaining sand, fines and water combine to form “tailings”. Tailings are typically discharged and contained in large tailings ponds. The larger sand particles in the tailings settle to form a stable deposit fairly quickly while the finer clay particles sometimes take years to settle and are known as fluid fine tailings. Through treatment, tailings pond water can be reclaimed and the water reused.

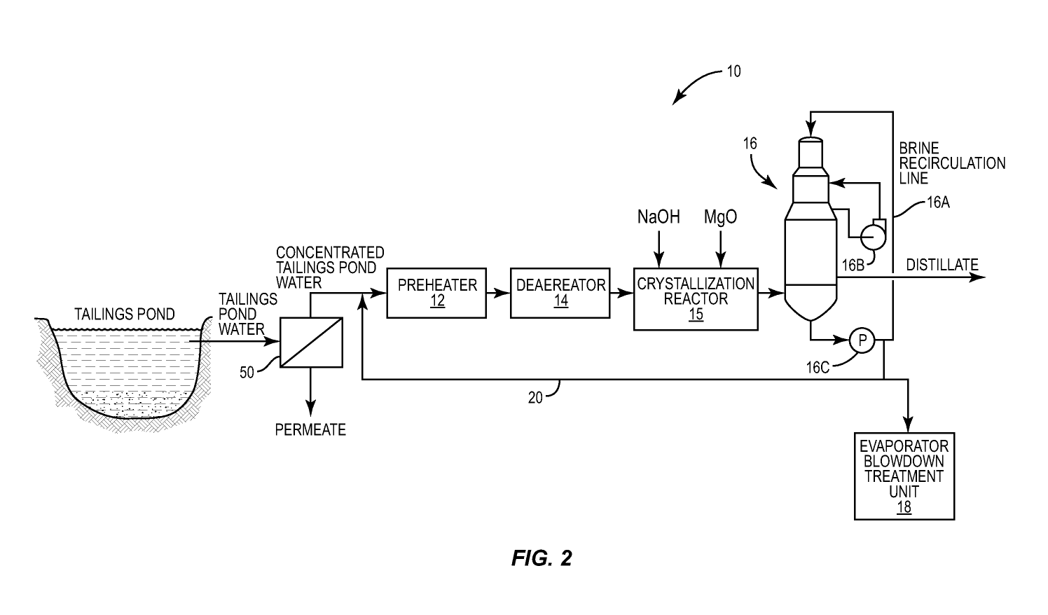

FIG. 2 shows a process for reclaiming tailings pond water. As seen in FIG. 2, tailings pond water is pumped from a tailings pond to a membrane separation unit 50 for treatment. The membrane separation unit 50 can be of various types. In one embodiment, it comprises one or more reverse osmosis units. The tailings pond water is directed into the membrane separation unit under pressure. A permeate is produced. In addition, the membrane separation unit produces a reject stream which, as FIG. 2 illustrates, is a concentrated tailings pond water. This reject stream or the concentrated tailings pond water typically has a relatively high concentration of alkalinity (e.g. 2000 ppm) and is directed to and through the pre-heater 12, deaerator 14 and crystallization reactor 15 as previously discussed. Indeed, the concentrated tailings pond water is subjected to the same process discussed in FIG. 1 with respect to the oil sands process water. Here again, calcium carbonate is crystallized through a process where the addition of magnesium oxide to the concentrated tailings pond water causes magnesium hydroxide to precipitate and the crystallization reactor 15 also functions to cause the calcium carbonate particles to form calcium carbonate crystals as the pH increases. Because of the formation of magnesium hydroxide crystals, the solid calcium carbonate particles do not scale the evaporator heat transfer tubes. Like the FIG. 1 process, the process described in FIG. 2 will also prevent silica from scaling the heat transfer tubes.

In the above discussions, the process has discussed treating oil sands process water including, for example, produced water and tailings pond water. However, the process of the present invention is also applicable to other industrial wastewater streams, particularly those wastewater streams that are treated with an evaporator and which include a significant concentration of alkalinity and calcium hardness. For example, the process of the present invention can be used to treat coal seam gas produced water, gas field produced water and other industrial waste streams. The same process is employed. By mixing magnesium oxide with the wastewater stream, magnesium hydroxide is precipitated and also due to a pH increase calcium carbonate is precipitated and crystallized. The crystallization process involving the magnesium hydroxide assures that the calcium carbonate solids do not scale the evaporator heat transfer tubes or even other process equipment that is utilized in the treatment of such wastewater streams.

From the foregoing specification and discussion, it is appreciated that the process of the present invention is directed at treating oil sands process water and other wastewater streams by evaporating the water and employing upstream processes, prior to evaporation, that are designed to prevent calcium carbonate from scaling the heat transfer tubes of the evaporator. This is accomplished by adding magnesium oxide, and in some cases sodium hydroxide, in order to establish conditions that promote the precipitation and crystallization of calcium carbonate. Once in a crystallized form, the calcium carbonate will not significantly scale the heat transfer tubes of the evaporator 16.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of treating oil sands process water (OSPW) having alkalinity and calcium hardness, comprising:
directing the OSPW having alkalinity and hardness to an evaporator;
evaporating the OSPW in the evaporator to produce steam and a concentrated brine;
condensing the steam produced by the evaporator to form a distillate;
inhibiting calcium carbonate scaling of the evaporator by:
i. upstream of the evaporator, mixing a magnesium source with the OSPW in one or more reactors which form magnesium hydroxide crystals and precipitating calcium carbonate from the OSPW;
ii. crystallizing the calcium carbonate to form calcium carbonate crystals in the OSPW;
iii. directing a mixed crystal slurry comprising the magnesium hydroxide and calcium carbonate crystals, along with the OSPW to the evaporator where the mixed crystal slurry is mixed with the concentrated brine;
iv. circulating the concentrated brine and mixed crystal slurry through the evaporator; and
v. circulating at least some of the concentrated brine and mixed crystal slurry therein to the one or more reactors or to a point upstream of the one or more reactors and mixing the concentrated brine and mixed crystal slurry with the OSPW.

2. The method of claim 1 including raising the pH of the OSPW upstream of the evaporator to 10.2 to 11.5 by mixing a caustic with the OSPW.

3. The method of claim 1 including producing the OSPW by directing a feedwater stream into a membrane separation unit and producing a permeate stream and a reject stream and wherein the reject stream constitutes to OSPW;
after directing the feedwater stream through the membrane separation unit and producing the OSPW and prior to mixing the magnesium source with the OSPW, preheating the OSPW with a preheater and directing the OSPW through a deaerator and removing non-condensable gases.

4. The method of claim 1 including a membrane separation unit disposed upstream of the one or more reactors and the method including directing a feedwater stream into the membrane separation unit and producing a permeate stream and a reject stream and wherein the OSPW treated in the one or more reactors is the reject stream from the membrane separation unit.

5. The method of claim 1 wherein the OSPW also includes dissolved silica and the method entails inhibiting silica scaling of the evaporator by mixing the magnesium oxide with the OSPW to precipitate magnesium hydroxide; and the method includes removing dissolved silica from the OSPW by adsorbing the silica onto the magnesium hydroxide precipitants.

6. The method of claim 1 including prior to mixing the magnesium source with the OSPW, directing the OSPW through a pre-heater and a deaerator.

7. The method of claim 1 including heating the OSPW by directing the OSPW through a heater located upstream of the one or more reactors and causing calcium carbonate to precipitate from the OSPW.

8. The method of claim 7 wherein after heating the OSPW, directing the OSPW through a de-aeration device and removing non-condensable gases from the OSPW.

9. The method of claim 1 including directing the distillate to a steam generation system or discharging the distillate or utilizing the distillate as makeup process water.

10. A method for treating tailings pond water having alkalinity and hardness comprising:
directing, directly or indirectly, the tailings pond water from a tailings pond to a membrane separation unit;
directing the tailings pond water through the membrane separation unit and producing a permeate and concentrated tailings pond water having alkalinity and calcium hardness;
directing the concentrated tailings pond water to an evaporator;
evaporating the concentrated tailings pond water in the evaporator to produce steam and a concentrated brine;
condensing the steam produced by the evaporator to form a distillate;
inhibiting calcium carbonate scaling of the evaporator by:
i. upstream of the evaporator, mixing a magnesium source with the concentrated tailings pond water in one or more reactors;
ii. precipitating magnesium hydroxide and forming a seed for calcium carbonate;
iii. precipitating calcium carbonate from the concentrated tailings pond water;
iv. crystallizing the magnesium hydroxide and calcium carbonate to form a mixed crystal slurry in the concentrated tailings pond water;
v. directing the mixed crystal slurry along with the concentrated tailings pond water to the evaporator where the magnesium hydroxide and calcium carbonate crystals are mixed with the concentrated brine;
vi. circulating the concentrated brine and mixed crystal slurry through the evaporator; and
vii. circulating at least some of the concentrated brine and mixed crystal slurry therein to the one or more reactors or to a point upstream of the one or more reactors and mixing the concentrated brine and mixed crystal slurry with the concentrated tailings pond water.

11. The method of claim 10 including raising the pH of the concentrated tailings pond water upstream of the evaporator by mixing a caustic with the concentrated tailings pond water.

12. The method of claim 11 including raising the pH of the concentrated tailings pond water to 10.2 to 11.5.

13. The method of claim 11 wherein the concentrated tailings pond water also includes dissolved silica and the method entails inhibiting silica scaling of the evaporator by mixing magnesium oxide with the concentrated tailings pond water to precipitate magnesium hydroxide; and the method further including removing dissolved silica from the concentrated tailings pond water by adsorbing the silica onto the magnesium hydroxide precipitants.

14. The method of claim 11 including prior to mixing the magnesium oxide with the concentrated tailings pond water, directing the concentrated tailings pond water through a pre-heater and a deaerator.

15. A method of treating industrial wastewater having alkalinity and calcium hardness, comprising:
directing the wastewater having alkalinity and hardness to an evaporator;
evaporating the wastewater in the evaporator to produce steam and a concentrated brine;
condensing the steam produced by the evaporator to form a distillate;
inhibiting calcium scaling of the evaporator by:
i. upstream of the evaporator, mixing a magnesium source with the wastewater in one or more reactors;
ii. precipitating magnesium hydroxide from the wastewater wherein the precipitated magnesium hydroxide acts as a seed for a calcium species or compound;
iii. precipitating a calcium species or compound from the wastewater;
iv. directing the precipitated magnesium hydroxide and calcium species or compound, along with the wastewater to the evaporator where the precipitated magnesium hydroxide and calcium species or compound are mixed with the concentrated brine;
v. circulating the concentrated brine along with the magnesium hydroxide and calcium species or compound through the evaporator; and
vi. circulating at least some of the concentrated brine and precipitated calcium species or compound and magnesium hydroxide therein to the one or more reactors or to a point upstream of the one or more reactors and mixing the concentrated brine and the precipitated magnesium hydroxide and calcium species or compound therein with the wastewater.

16. The method of claim 15 including raising the pH of the wastewater upstream of the evaporator by mixing a caustic with the wastewater.

17. The method of claim 16 including raising the pH of the wastewater to 10.5 to 11.5.

18. The method of claim 15 including a membrane separation unit disposed upstream of the one or more reactors and the method including directing a feedwater stream into the membrane separation unit and producing a permeate stream and a reject stream and wherein the wastewater treated in the one or more reactors is the reject stream from the membrane separation unit.

19. The method of claim 15 wherein the wastewater also includes dissolved silica and the method entails inhibiting silica scaling of the evaporator by mixing the magnesium oxide with the wastewater to precipitate magnesium hydroxide; and the method includes removing dissolved silica from the wastewater by adsorbing the silica onto the magnesium hydroxide precipitants.

20. The method of claim 15 wherein the magnesium source is magnesium oxide.

21. The method of claim 1 wherein the magnesium source is magnesium oxide.

22. The method of claim 10 wherein the magnesium source is magnesium oxide.

23. The method of claim 15 wherein the calcium species or compound comprises calcium carbonate and the method includes precipitating magnesium hydroxide from the wastewater wherein the precipitated magnesium hydroxide acts as a seed for calcium carbonate and the method includes circulating at least some of the concentrated brine and precipitated calcium carbonate and magnesium hydroxide therein to the one or more reactors or to a point upstream of the one or more reactors and mixing the concentrated brine and the precipitated magnesium hydroxide and calcium carbonate therein with the wastewater.
